(19) United States
(12) Patent Application Publication
(10) Pub. No.: US 2017/0134625 A1
(43) Pub. Date: May 11, 2017

(54) DEDICATED ILLUMINATION ELEMENT AND DISPLAY BASED FLASH ILLUMINATION FOR IMAGE CAPTURE

(71) Applicant: QUALCOMM Incorporated, San Diego, CA (US)

(72) Inventors: Nathaniel Salazar, San Diego, CA (US); Sandeep Dhar, San Diego, CA (US); Todd Sutton, Del Mar, CA (US)

(21) Appl. No.: 14/936,405

(22) Filed: Nov. 9, 2015

(51) Int. Cl. H04N 5/225; H04N 5/235; H04N 5/232; G06T 7/40

(52) U.S. Cl. CPC H04N 5/2256; G06T 7/408; H04N 5/2354; H04N 5/23293

(57) ABSTRACT

Systems and methods for illuminating a subject for image capture are described herein. A processor may determine an ambient color temperature of a subject. The processor may further determine a color temperature for outputting light from a display facing a first direction based on a light output characteristic for a dedicated illumination element facing the first direction, the determined ambient color temperature, and a desired color temperature of the subject. The processor may further illuminate the subject using both the dedicated illumination element and the display. The display may output light based on the determined color temperature for outputting light from the display. The processor may further capture, using an image sensor facing the first direction, an image of the subject during the subject being illuminated using both the dedicated illumination element and the display.

### FIELD OF THE DISCLOSURE

This disclosure relates to camera imaging techniques. In particular, this disclosure relates to utilizing a dedicated illumination element and display of a device as a flash to illuminate a scene during capture of an image.

### BACKGROUND

Many mobile devices (e.g., smartphones, tablets, laptops, etc.) include a display and a front-facing camera that is configured to take a picture or record video of a subject in front of the mobile device (i.e., the camera is facing the same direction as the display). These front-facing cameras are often used by a user of the mobile device to take photos of themselves, known as “selfies.” The front-facing camera may capture an image of the user and display the image of the user on the display so the user can see themselves in the display of the mobile device while taking a picture of themselves.

Use of the front-facing camera in a mobile device in low light situations may lead to a low quality image for images captured using the front-facing camera. For example, the front-facing camera may utilize an image sensor (e.g., charge-coupled device (CCD), complementary metal-oxide semiconductor (CMOS), etc.) with a limited sensor quality (e.g., small pixel size, low resolution, etc.) due to design constraints of the mobile device. Such an image sensor may not be capable of capturing enough light during the image capture process, which may lead to a noisy, dark, washed out, flat, and/or improperly colored captured image.

### SUMMARY

One aspect of the teachings of the disclosure relates to a mobile device comprising a memory and a processor. The processor is configured to determine an ambient color temperature of a subject. The processor is further configured to determine a color temperature for outputting light from a display facing a first direction based on a light output characteristic for a dedicated illumination element facing the first direction, the determined ambient color temperature, and a desired color temperature of the subject. The processor is configured to illuminate the subject using both the dedicated illumination element and the display. The display outputs light based on the determined color temperature for outputting light from the display. The processor is configured to capture, using an image sensor facing the first direction, an image of the subject during the subject being illuminated using both the dedicated illumination element and the display.

Another aspect of the teachings of the disclosure relates to a method for illuminating a subject for image capture. The method comprises determining an ambient color temperature of a subject. The method further comprises determining a color temperature for outputting light from a display facing a first direction based on a light output characteristic for a dedicated illumination element facing the first direction, the determined ambient color temperature, and a desired color temperature of the subject. The method further comprises illuminating the subject using both the dedicated illumination element and the display. The display outputs light based on the determined color temperature for outputting light from the display. The method further comprises capturing, using an image sensor facing the first direction, an image of the subject during the subject being illuminated using both the dedicated illumination element and the display.

Yet another aspect of this disclosure relates to a mobile device comprising means for determining an ambient color temperature of a subject. The mobile device further comprises means for determining a color temperature for outputting light from a display facing a first direction based on a light output characteristic for a dedicated illumination element facing the first direction, the determined ambient color temperature, and a desired color temperature of the subject. The mobile device further comprises means for illuminating the subject using both the dedicated illumination element and the display. The display outputs light based on the determined color temperature for outputting light from the display. The mobile device further comprises means for capturing, using an image sensor facing the first direction, an image of the subject during the subject being illuminated using both the dedicated illumination element and the display.

Another aspect of this disclosure relates to a non-transitory computer readable medium having stored thereon instructions that, when executed, cause a processor of a device to perform a method for illuminating a subject for image capture. The method comprises determining an ambient color temperature of a subject. The method further comprises determining a color temperature for outputting light from a display facing a first direction based on a light output characteristic for a dedicated illumination element facing the first direction, the determined ambient color temperature, and a desired color temperature of the subject. The method further comprises illuminating the subject using both the dedicated illumination element and the display. The display outputs light based on the determined color temperature for outputting light from the display. The method further comprises capturing, using an image sensor facing the first direction, an image of the subject during the subject being illuminated using both the dedicated illumination element and the display.

### BRIEF DESCRIPTION OF THE DRAWINGS

FIG. 1 is a graph illustrating the color temperature of light if a single dedicated illumination element alone is used as a flash to illuminate a subject.

FIG. 2 is a graph illustrating the color temperature of light if a display alone is used as a flash to illuminate a subject.

FIG. 3 is a graph illustrating examples of the color temperature of light if a display is used in combination with another dedicated illumination element as a flash to illuminate a subject.

FIG. 4 is a functional block diagram of an example of an image capture device.

FIG. 5 is an illustration of an example of an image capture device.

FIG. 6 is a flowchart for a process for illuminating a subject in order to take a picture of the subject.

FIG. 7 is a flowchart for a process for taking a picture with a display of an image capture device used to illuminate a subject of the picture.

FIG. 8 is a flowchart for a process for determining the color temperature to output from an image capture device to illuminate a subject.

### DETAILED DESCRIPTION

This disclosure relates to systems and methods for illuminating a subject (e.g., object, person, landscape, etc.) of a photo taken by a front-facing image sensor (i.e., image sensor facing the same direction as a display) of an image capture device (e.g., smartphone, tablet, mobile device, laptop, digital camera, etc.) based on a selected color temperature (e.g., the ambient color temperature of the subject, a specific color temperature, and/or a desired color temperature for the subject) (and optionally a desired luminance for the subject). The image sensor may also be referred to as a camera herein. In some embodiments, the subject of the photo is illuminated using a display (e.g., liquid crystal display (LCD), organic light emitting diode (OLED), active matrix OLED (AMOLED), interferometric modulator display, etc.) of the image capture device and a dedicated illumination element (e.g., LED (light emitting diode) light, xenon light, flashtube, etc.) of the image capture device as a flash, wherein the light output of the display and the dedicated illumination element combined is based on the selected color temperature.

For example, in some embodiments, the combined light output may be approximately the ambient color temperature of the subject (e.g., as measured by the image capture device). Further, in some embodiments, the combined light output may be at approximately a specific color temperature, such as a specific color temperature set by a user of the image capture device. In some other embodiments, the combined light output may cause the subject to be illuminated at approximately a desired color temperature for the subject. For example, the user may select a desired color temperature for the subject, further the image capture device may measure an ambient color temperature of the subject, and the combined light output may be selected such that the combination of the light output from the display, dedicated illumination element, and the ambient light already on the subject is approximately at the desired color temperature of the subject.

As used herein, being “approximately” a particular color temperature (e.g., selected color temperature, desired color temperature, specific color temperature, ambient color temperature, etc.) may refer to being within 10% of the particular color temperature. Further, being “approximately” a particular luminance may refer to being within 10% of the particular luminance.

It should be noted that certain embodiments are described with respect to taking a picture (also referred to as a “photo”). However, such techniques can also readily be used with respect to video capture, which is essentially taking several pictures in sequence.

The color temperature of light (e.g., ambient color temperature of a subject, specific color temperature, and/or desired color temperature for a subject) may in one example be defined as a correlated color temperature (CCT). The CCT rating of light is a measure of the color appearance of a light source relating to the color output to that of a blackbody radiator heated to a specific absolute temperature measured in Kelvin. Lower Kelvin values correspond to a “warmer” appearance with more reddish tones. A higher Kelvin value corresponds to a “cooler” appearance with more bluish tones.

Different light sources may be used to illuminate a subject such as halogen light, incandescent light, fluorescent light, sun light, moon light, etc. Each of these light sources may output a different color temperature of light on the subject. If the subject is then further illuminated by an additional light source that has a different color temperature than the original light source, the look of the subject may change undesirably. For example, the subject may be further illuminated by using a light source (e.g., display, dedicated illumination element) as a flash to further illuminate the subject during image capture of the subject. The term “flash” therefore, as used herein with respect to illumination, may be any combination of light sources used to further illuminate a subject during the image capture process that is in addition to any light sources that are generally providing illumination of the subject.

Accordingly, in some embodiments, the image capture device may determine the ambient color temperature of a subject to determine how to further illuminate the subject in order to take a picture of the subject. By further illuminating the subject with a color temperature that matches the ambient color temperature, the user experience and quality of photo taken by an image capture device (e.g., an application running on a smartphone that takes photos using a front-facing camera) may be improved. In particular, the photo taken may have more true-to-life colors and/or more natural-looking skin tones.

In addition, in embodiments where the user is able to set a specific color temperature or a desired color temperature that determines the color temperature for the further illumination, the user can have more creative control over the resulting photo taken. In particular, a user may be able to take photos with artistic and/or interesting color schemes.

In some embodiments, the image capture device may include a separate sensor or sensors to determine ambient color temperature (and optionally luminance) of a subject. In some embodiments, the same image sensor used to take a picture of the subject is also used to capture an image of the subject before taking a picture, and calculate the ambient color temperature (and optionally luminance). The difference between capturing an image and taking a picture, may be that capturing an image refers to the image sensor capturing an image without storing the image as a picture for later review, and taking a picture may mean the captured image is additionally stored in a non-volatile memory (e.g., in memory such as a flash based memory) such as for later review. A captured image that is not stored in a non-volatile memory (or even a taken picture) may be used for processing techniques such as image preview on a display of the device that displays a preview of what the image sensor is capturing, determining a luminance of the subject, determining an ambient color temperature for the subject being captured by the image sensor, etc.

The ambient color temperature may be determined using known imaging techniques (e.g., RGB metering). For example, some embodiments can determine pixels corresponding to a foreground and pixels corresponding to a background of the subject of the captured image and analyze the background pixels to determine the color temperature. Further, in some embodiments, the R/G (red to green) and B/G (blue to green) ratios of the ambient light captured are used by the image capture device to determine the ambient color temperature of light and/or an appropriate output (e.g., color temperature, luminance, etc.) for the dedicated illumination element and/or display in order to take a picture of the subject at the desired ambient color temperature or desired color temperature for the illumination of the subject.

The image capture device may further be configured to determine a luminance level of the subject using known techniques (e.g., RGB metering). For example, some embodiments measure the luminance of the captured image of the subject. The determined luminance level may be compared by the image capture device to a desired luminance level for the subject, and the image capture device may determine an appropriate output (e.g., color temperature, luminance, etc.) for the dedicated illumination element and/or display in order to take a picture of the subject at the desired luminance level. It should be noted that in some embodiments, the determined ambient color temperature for the illumination of the subject and desired luminance level may both be used to determine the output (e.g., color temperature, luminance, etc.) for the dedicated illumination element and/or display of the image capture device as discussed further herein. In particular, the dedicated illumination element and display of the image capture device may be configured to output light at different color temperatures and/or luminance as discussed herein.

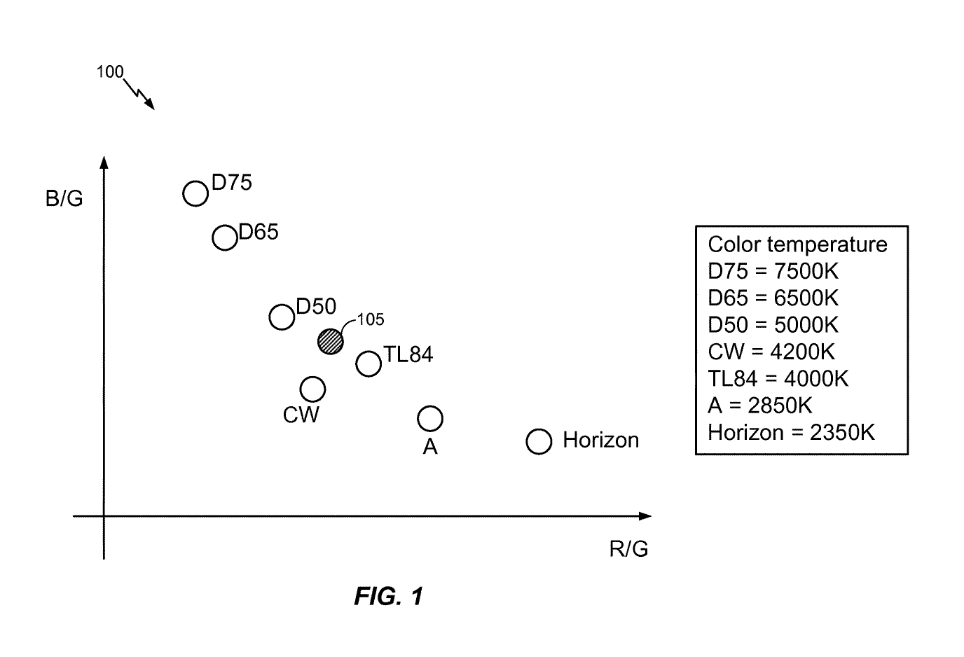

FIG. 1 is a graph 100 illustrating the color temperature of light if a single dedicated illumination element alone is used as a flash to illuminate a subject. The x-axis represents the R/G ratio of light and the y-axis represents the B/G ratio. The point 105 represents the color temperature produced by a single dedicated illumination element (e.g., and LED light). As shown the color temperature at point 105 is approximately somewhere between 4000K-5000K. However, it should be noted that the dedicated illumination element may be created to have any particular color temperature. This color temperature, however, remains constant and cannot be changed after it is incorporated in an image capture device.

The remaining points are the color temperatures of some other typical light sources. As shown in the legend, points are described using the scientific shorthand (e.g., D75) for CCT, which correspond to a specific CCT in Kelvin. As can be seen, the single dedicated illumination element is unable to produce light of the same color temperature as many typical light sources. For example, a dedicated illumination element (e.g., LED (light emitting diode) light, xenon light, flashtube, etc.) of an image capture device may be capable of outputting light at only a single color temperature. The dedicated illumination element, however, may be able to output light at different luminance levels. Further, there may be multiple dedicated illumination elements that output light at different color temperatures, and different combinations of different luminance levels for the multiple dedicated illumination elements may be used to create a limited number of different color temperatures for the combined light output from the multiple dedicated illumination elements. However, it may be design or cost prohibitive to include multiple dedicated illumination elements in some cases. For example, there may not be enough space on the display side of the image capture device to include multiple dedicated illumination elements and still have the image capture device be aesthetically pleasing.

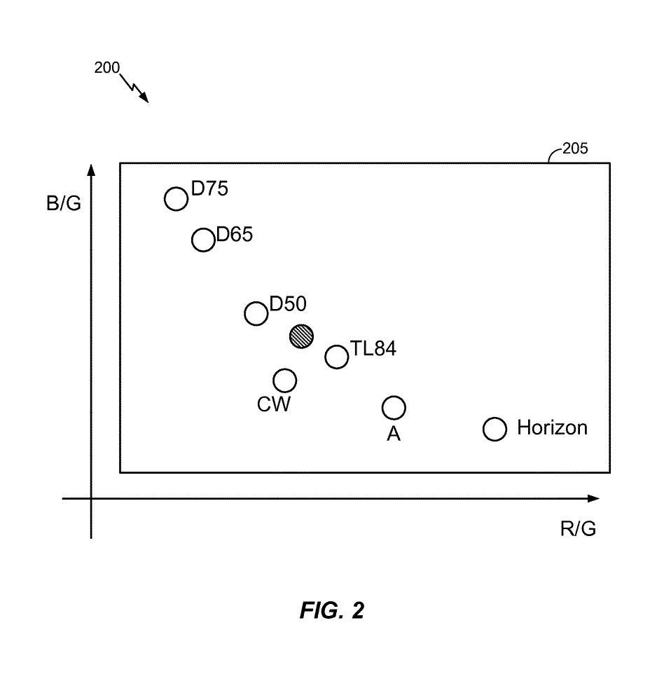

FIG. 2 is a graph 200 illustrating the color temperature of light if a display (e.g., liquid crystal display (LCD), organic light emitting diode (OLED), active matrix OLED (AMOLED), interferometric modulator display, etc.) alone is used as a flash to illuminate a subject. The x-axis represents the R/G ratio of light and the y-axis represents the B/G ratio. A display may be capable of representing substantially all the color temperatures (as illustrated by area 205), including those of typical light sources (shown as points on the graph). Further, the luminance level of a display may be varied. For example, the display of the image captured device may output light at a color temperature and/or luminance that is approximately uniform (e.g., certain imperfections or design features in the display may mean the output is not exactly uniform, but may be, for example, within 5% of the color temperature and/or luminance across the entire display) across an entire surface area of the display. In other examples, the display may output light at different color temperatures and luminance across the surface area of the display. For example, the display may be divided into regions (i.e., areas) of any shape or size (e.g., rectangular grid, square pattern, circles on a background, etc.). Each region or different groups of regions may output light at different color temperatures and/or luminance so that the combined light output from the different regions of the display has a desired luminance and color temperature (e.g., the ambient color temperature of a subject).

However, a display may not be capable of outputting a high luminance (e.g., the maximum lumen output of the display may be limited). Accordingly, the display alone may not be capable of outputting enough light to illuminate the subject in certain conditions.

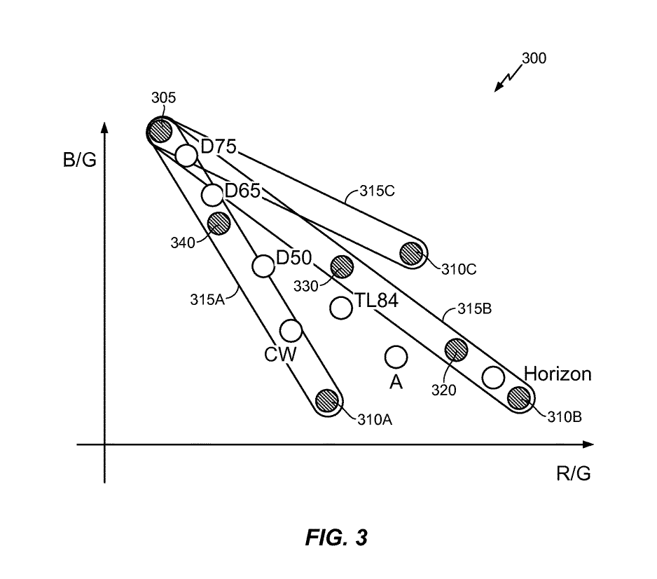

FIG. 3 is a graph 300 illustrating examples of the color temperature of light if a display is used in combination with another dedicated illumination element as a flash to illuminate a subject. The x-axis represents the R/G ratio of light and the y-axis represents the B/G ratio. Point 305 represents the color temperature produced by a dedicated illumination element. Points 310A, 310B, and 310C represent different color temperatures the display (e.g., uniformly or based on combined regions) can be set to output light at.

Using the combination of the display and the dedicated illumination element as a flash to illuminate the subject may allow the color temperature to be adjusted for the light output described herein, while also providing a higher output luminance for the flash as compared to using a display alone as a flash. For example, a display (e.g., in a smartphone) may have a light output of approximately 350 lumens (e.g., approximately 120 lux at a viewing angle of 120 degrees and a distance of 1 meter). In addition, a display may be capable of momentarily outputting light at a higher output such as approximately 700 lumens (e.g., approximately 240 lux at a viewing angle of 120 degrees and a distance of 1 meter). In contrast, a dedicated illumination element may have a light output of approximately 1000 lumens (e.g., approximately 300 lux at a viewing angle of 120 degrees and a distance of 1 meter). Therefore, use of a display alone as a flash, may not be as effective in illuminating a subject as a dedicated illumination element (e.g., may not be able to illuminate a subject at as great a distance from the subject). Further, using a dedicated illumination element alone as a flash, does not allow the color temperature of the light output to be adjusted. However, by combining the use of a display and dedicated illumination element as described herein, the color temperature of the light output can be adjusted, and the light can be output at a higher luminance (e.g., approximately 1700 lumens (e.g., approximately 540 lux at a viewing angle of 120 degrees and a distance of 1 meter)) than the display alone or even just the dedicated illumination element alone. This may allow subjects to be illuminated at a greater distance, thereby allowing images to be illuminated and captured by an image capture device from greater distances than the use of a display alone or even a dedicated illumination element alone. For example, at a distance of 1 meter, the light output of the combination of the display and dedicated illumination element used as a flash may be approximately 540 lux, which is approximately 80% greater than the 300 lux of the dedicated illumination element alone used as a flash, and 125% greater than the 240 lux of the display alone used as a flash.

As discussed with respect to FIG. 2, the display may be set to substantially all color temperatures in the area 205. Lines 315A, 315B, and 315C represent the color temperatures of light output that are possible by combining the output of the dedicated illumination element and the display as set to output light with a color temperature as indicated by points 310A, 310B, and 310C, respectively. The color temperatures of light output by the combination of the dedicated illumination element and display along a given line 315A-C can be achieved by adjusting the ratio of luminance of light output from the dedicated illumination element and the display (e.g., uniformly or based on combined regions). For example, the higher the ratio of dedicated illumination element luminance to display luminance, the closer the color temperature of the combined light output is to the color temperature of the dedicated illumination element (e.g., point 305). Further, the lower the ratio of dedicated illumination element luminance to display luminance, the closer the color temperature of the combined light output is to the color temperature of the display (e.g., points 310A-310C). Accordingly, the luminance of the display and the dedicated illumination element, and the color temperature of the light output of the display may be adjusted to create a light output of the desired color temperature and luminance.

In some embodiments, the ratio of luminance of the display to the dedicated illumination element, and the color temperature of the display (e.g., uniformly or based on combined regions) is based on a formula and calculated by the image capture device for a given specific color temperature (e.g., point 320) or determined ambient color temperature (e.g., and optionally desired luminance for the combined light output). For example, where the ratio of luminance of the display to the dedicated illumination element, and the color temperature of the display are based on the determined ambient color temperature they may be set so the combined light output has the same color temperature as the ambient color temperature (e.g., point 330) or so that the combined light output along with the ambient light has a desired color temperature for the subject (e.g., point 340).

In some embodiments, a table (or other data structure relating the data) is stored in a memory of the image capture device that indicates the ratio of luminance of the display to the dedicated illumination element, and the color temperature of the display (e.g., uniformly or based on combined regions) based on the specific color temperature or determined ambient color temperature (e.g., and optionally desired luminance for the combined light output). Where combined regions of different luminance and/or color temperature are used for the output from the display, the pattern to be output by the display for a given luminance and/or color temperature may be predetermined and stored as a pattern for output in the image capture device.

In some embodiments, to set the ratio of luminance between the dedicated illumination element and display, and set the color temperature of the display before taking a picture, the image capture device may turn on the dedicated illumination element and display at an estimated ratio of luminance and estimated color temperature of the display. The estimated values may be based on the specific color temperature or the determined ambient color temperature of the subject, and determined using a table or formula as described. The image capture device may be configured to detect the combined light output of the dedicated illumination element and the display (e.g., according to similar techniques as used to determine the ambient color temperature) and adjust the luminance of the dedicated illumination element, luminance of the display, and/or color temperature of the display if it is determined the combined light output does not equal the specific color temperature, determined ambient color temperature, or desired color temperature for the subject. The image capture device may be configured to continue adjusting the luminance of the dedicated illumination element, luminance of the display, and/or color temperature of the display until the mismatch is resolved. For example, the image capture device may intermittently or continuously make adjustments and determine the color temperature of the combined light output.

In some embodiments, in a preview mode, a preview image is displayed on the display of the image capture device indicating the current image captured by the image sensor device, until a picture is taken by the image capture device. At the time the picture is being taken by the image capture device, the display may flash during image capture with a light output to illuminate the subject with an appropriate color temperature (and optionally luminance) as discussed herein, store the captured image as a picture, and then revert to displaying an image on the display (e.g., another preview image, an image of the stored pictured, etc.).

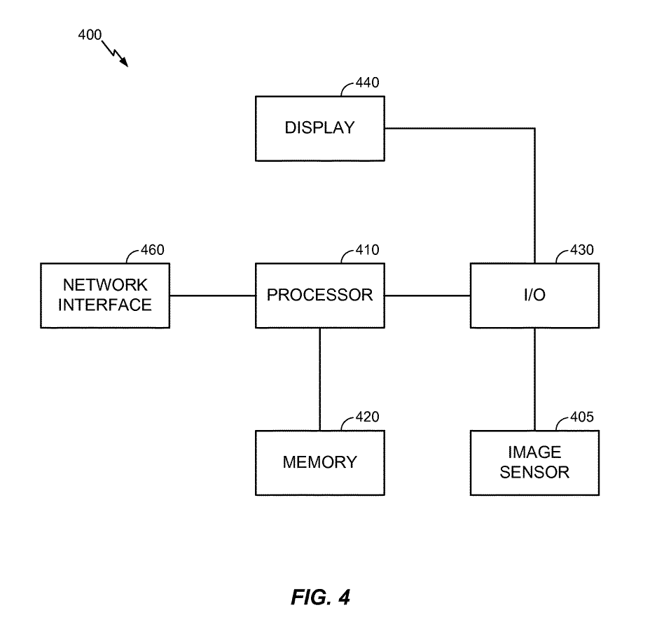

FIG. 4 is a functional block diagram of an image capture device 400. For example, the image capture device 400 may correspond to any appropriate image capture device including a smartphone, digital camera, etc. The image capture device 400 may be configured to implement some or all of the teachings discussed herein, including the teachings described with respect to FIGS. 1-3. For example, the image capture device 400 may be configured to determine an ambient color temperature of light of a subject, determine a luminance of a subject, determine a desired luminance of a subject, capture an image, take a picture, display a preview of an image, determine a light output (e.g., color temperature, luminance, etc.) of a dedicated illumination element of the image capture device, determine a light output (e.g., color temperature, luminance, etc.) of a display of the image capture device, etc.

The image capture device 400 includes a processor 410 in data communication with a memory 420, and an input/output interface 430. The input/output interface 430 is further in data communication with a display 440 (e.g., liquid crystal display (LCD), organic light emitting diode (OLED), active matrix OLED (AMOLED), etc.) and an image sensor 405 (e.g., charge-coupled device (CCD), complementary metal-oxide semiconductor (CMOS), etc.). The input/output interface 430 is also in data communication with a dedicated illumination element 445 (e.g., LED (light emitting diode) light, xenon light, flashtube, etc.). The processor 410 is further in data communication with a network interface 460. Although described separately, it is to be appreciated that functional blocks described with respect to the image capture device 400 need not be separate structural elements. For example, the processor 410 and memory 420 may be embodied in a single chip. Similarly, two or more of the processors 410, and network interface 460 may be embodied in a single chip. The image capture device 400 may be configured to perform the functions described herein. For example, the processor 410 may be configured to execute instructions stored in the memory 420 that cause the image capture device 400 to perform the functions and processes described herein.

The processor 410 can be a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

The processor 410 can be coupled, via one or more buses, to read information from or write information to memory 420. The processor may additionally, or in the alternative, contain memory, such as processor registers. The memory 420 can include processor cache, including a multi-level hierarchical cache in which different levels have different capacities and access speeds. The memory 420 can also include random access memory (RAM), other volatile storage devices, or non-volatile storage devices. The storage can include hard drives, optical discs, such as compact discs (CDs) or digital video discs (DVDs), flash memory, floppy discs, magnetic tape, and Zip drives.

The processor 410 is also coupled to an input/output interface 430 for, receiving input from and providing output to, devices connected to the image capture device 400. Examples of such devices include, but are not limited to, a keyboard, buttons, keys, switches, a pointing device, a mouse, a joystick, a remote control, an infrared detector, a camera sensor (e.g., sensor 405), a DVD player, a Blu-ray player, a motion detector, a microphone (possibly coupled to audio processing software to, e.g., detect voice commands) visual output devices such as a touch-screen display (e.g., display 440), including displays and printers, audio output devices, including speakers, headphones, earphones, and alarms, and haptic output devices, including force-feedback game controllers and vibrating devices. The input/output interface 430 may use one or more protocols to, wirelessly or through a wired connection, communicate with devices including but not limited to universal serial bus (USB), FireWire, Thunderbolt, Light Peak, digital video interface (DVI), high-definition multimedia interface (HDMI), video graphics array (VGA), peripheral component interconnect (PCI), etc.

The processor 410 is further coupled to a network interface 460. The network interface 460 may comprise one or more modems. The network interface 460 prepares data generated by the processor 410 for transmission to a network or another device. The network interface 460 may also demodulates data received via the network. The network interface 460 can include a transmitter, receiver, or both (e.g., a transceiver). In other embodiments, the transmitter and receiver are two separate components. The network interface 460, can be embodied as a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. The network interface 460 may be a wired interface (e.g., Ethernet, local area network (LAN), etc.) and/or a wireless interface (e.g., Long-Term Evolution (LTE), wireless local area network (WLAN), WiFi, code division multiple access (CDMA), global system for mobile communications (GSM), worldwide interoperability for microwave access (WiMax), Bluetooth, etc.).

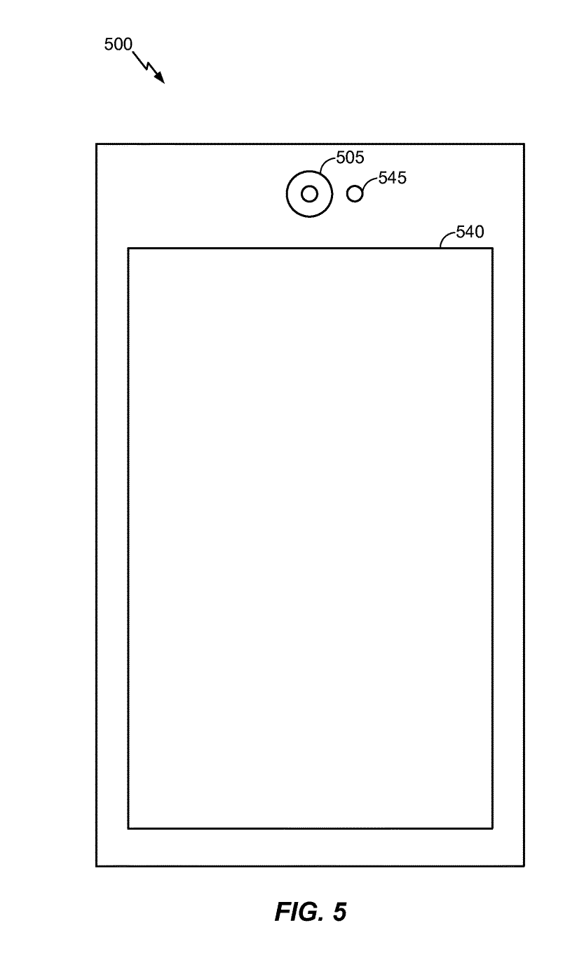

FIG. 5 is an illustration of an example image capture device 500. The image capture device 500, in some embodiments, may correspond to the image capture device 400. As shown, the image capture device 500 is a smartphone type device. The image capture device 500 includes an image sensor 505 (e.g., charge-coupled device (CCD), complementary metal-oxide semiconductor (CMOS), etc.), a display 540 (e.g., liquid crystal display (LCD), organic light emitting diode (OLED), active matrix OLED (AMOLED), etc. with a touchscreen input), and a dedicated illumination element 545 (e.g., LED (light emitting diode) light, xenon light, flashtube, etc.). As can be seen, the image sensor 505, display 540, and dedicated illumination element 545 are all facing the same direction. Internally, the image capture device 500 may have other components, such as one or more of the components described with respect to image capture device 400 that perform functions described with respect to image capture device 400. For example, the image capture device 500 may be configured to implement some or all of the teachings discussed herein, including the teachings described with respect to FIGS. 1-4. For example, the image capture device 500 may be configured to determine an ambient color temperature of light of a subject, determine a luminance of a subject, determine a desired luminance of a subject, capture an image, take a picture, display a preview of an image, determine a light output (e.g., color temperature, luminance, etc.) of a dedicated illumination element of the image capture device, determine a light output (e.g., color temperature, luminance, etc.) of a display of the image capture device, etc.

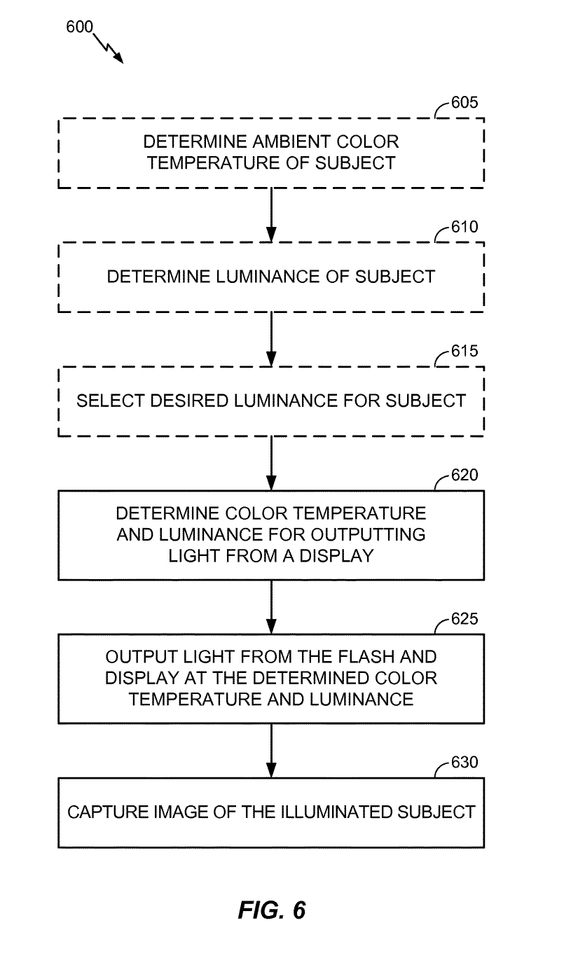

FIG. 6 is a flowchart for a process 600 for illuminating a subject in order to take a picture of the subject. At an optional block 605, the ambient color temperature of a subject of a picture to be taken using an image capture device may be determined. For example, in some embodiments, a sensor on the image capture device may directly measure the ambient color temperature of the subject. In some other embodiments, an image sensor of the image capture device may capture an image of the subject and determine an ambient color temperature of the subject based on the captured image.

At an optional block 610, a luminance of the subject may be determined. For example, the luminance of the subject may be measured using a sensor on the image capture device. In another example, the luminance may be determined based on measuring luminance in an image of the subject captured by the image capture device.

At another optional block 615, a desired luminance for the subject may be selected at the image capture device (e.g., by a user or automatically based on a predetermined desired luminance).

Further, at a block 620, a color temperature and luminance for outputting light from a display facing the same direction as the image sensor is determined. Optionally, if the luminance of a dedicated illumination element of the image capture device is adjustable, a luminance for the dedicated illumination element is also determined. In particular, in some embodiments, the color temperature for outputting light from the display is based on the specific color temperature selected (e.g., by a user) for light output and the luminance and color temperature of light output by the dedicated illumination element. In such embodiments, the determined color temperature for outputting light from the display may be selected so the light output from the dedicated illumination element and the display combined is approximately equal to the specific color temperature. In some embodiments, the color temperature for outputting light from the display is determined based on the determined ambient color temperature of the subject and the luminance and color temperature of light output by the dedicated illumination element. In some embodiments, the determined color temperature for outputting light from the display may be selected so the light output from the dedicated illumination element and the display combined is approximately equal to the determined ambient color temperature of the subject. In some embodiments, the determined color temperature for outputting light from the display may be selected so the light output from the dedicated illumination element and the display along with the ambient light on the subject combined is approximately equal to the desired color temperature for the subject.

Further, in some examples, the luminance for the display and/or dedicated illumination element may be preset, selectable (e.g. by a user), or determined so that the combined light output from the dedicated illumination element and the display causes the subject to be illuminated to the desired luminance for the subject. For example, the image capture device may be configured to determine the amount of additional light output required from the display to get the desired luminance of the subject based on the determined luminance of the subject without illumination from the display. Accordingly, the image capture device may be configured to determine the luminance for outputting light from the dedicated illumination element and the display based on the determined amount of additional light output required.

In some embodiments, the color temperature and luminance for outputting light from the display and dedicated illumination element may be determined based on a formula or by using a look up table. Further, the color temperature and luminance for outputting light from the display may be a uniform color temperature to output light from approximately the entire surface of the display, or a particular pattern output from the display that has a combined light output at the color temperature and luminance.

Continuing, at a block 625, the display may be configured to output light at the determined color temperature and luminance, and the dedicated illumination element may be configured to output light (optionally at the determined luminance) and illuminate the subject. At a block 630, the image capture device may be configured to capture an image (or take a picture) of the illuminated subject.

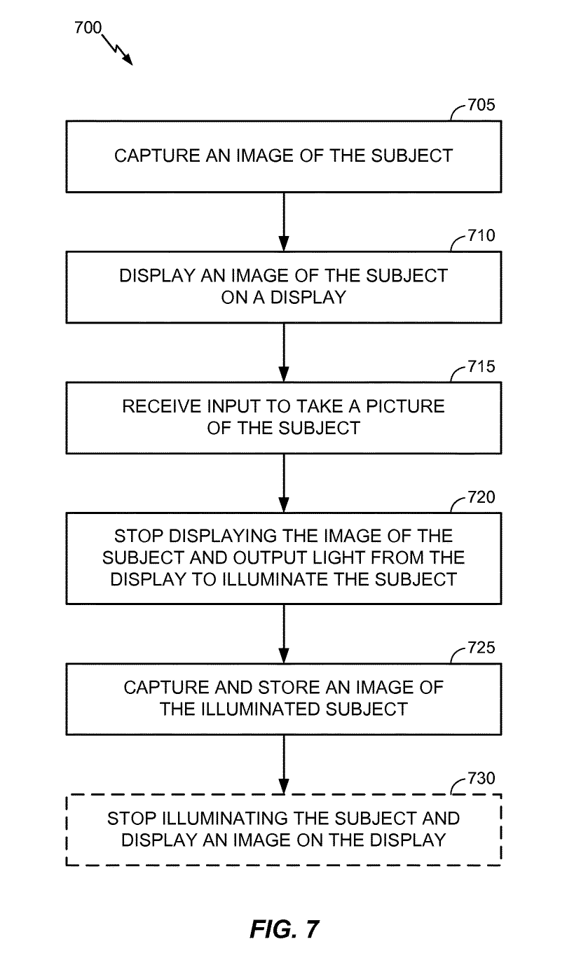

FIG. 7 is a flowchart for a process 700 for taking a picture with a display of an image capture device used to illuminate a subject of the picture. For example, the process 700 may be used in conjunction with processes like process 600 (e.g., to execute block 630). At a block 705, an image sensor facing the same direction as a display of the image capture device may be configured to capture an image of the subject. Further, at a block 710, the captured image of the subject may be displayed on the display (e.g., in a preview mode).

Continuing, at a block 715, an input may be received at the image capture device to take a picture of the subject. At a block 720, the display stops displaying the captured image of the subject and outputs light (e.g., according to a determined color temperature and luminance as described with respect to process 600) to illuminate the subject of the picture. Optionally, a dedicated illumination element of the image capture device may also illuminate the subject of the picture.

Further, at a block 725, the image capture device captured an image of the subject as it is illuminated and stores the captured image as a taken picture.

At an optional block 730, the display (and optionally the dedicated illumination element) stops illuminating the subject, and a new image (e.g., of the taken picture, a preview image, etc.) is displayed on the display.

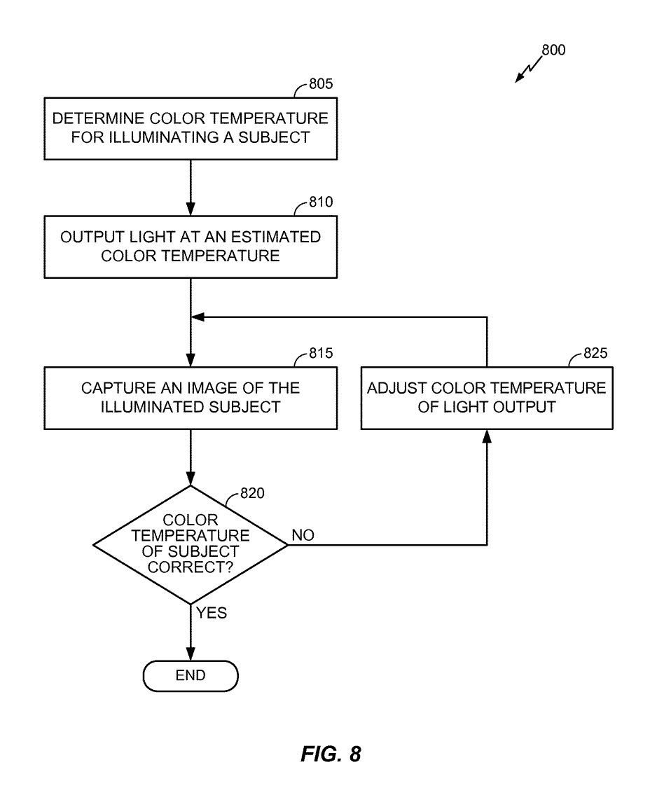

FIG. 8 is a flowchart for a process 800 for determining the color temperature to output from an image capture device to illuminate a subject. For example, the process 800 may be used in conjunction with processes like process 600 (e.g., to help execute blocks 610 and 620).

At a block 805, a color temperature (and optionally luminance) for illuminating a subject is determined (e.g., based on techniques as described herein including with respect to process 600). Further, at a block 810 light is output at an estimated color temperature and/or luminance from a display of the image capture device (and optionally a dedicated illumination element of the image capture device). The estimated color temperature and/or luminance may be based on the determined color temperature (and optionally luminance) for illuminating the subject as described herein. Continuing at a block 815, an image sensor of the image capture device captures an image of the illuminated subject.

Further, at a block 820, the image capture device determines if the color temperature and/or illumination of the subject in the captured image is approximately equal to the determined color temperature (and optionally luminance) for illuminating the subject. If at the block 820, the image capture device determines the color temperature and/or illumination of the subject in the captured image is approximately equal to the determined color temperature (and optionally luminance) for illuminating the subject, the estimated color temperature and/or luminance for light output from the display device (and optionally the dedicated illumination element of the image capture device) is set to be used to take a picture of the subject.

If at the block 820, the image capture device determines the color temperature and/or illumination of the subject in the captured image is not approximately equal to the determined color temperature (and optionally luminance) for illuminating the subject, the process continues to a block 825. At the block 825, the luminance and/or color temperature of the display (and optionally the luminance of the dedicated illumination element) is adjusted based on the difference between the determined color temperature and/or illumination of the subject in the captured image and the determined color temperature (and optionally luminance) for illuminating the subject. The process 800 then returns to the block 820.

It should be noted that any and all of the processes 600-800 are examples of processes that may be performed. One of skill in the art will understand that other similar processes may also be performed according to the teachings herein. For example, one or more blocks of the processes 600-800 may be added, removed, and/or changed in the order performed.

Any and all of the processes 600-800 may be performed by an image capture device, such as any of the image capture devices 400 and 500 described herein. In some embodiments, the processes 600-800 may be performed by hardware and/or software on an image capture device (e.g., processor, image sensor, display, dedicated illumination element, memory, etc.). For example, the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The techniques described herein may be implemented in hardware, software, firmware, or any combination thereof. Such techniques may be implemented in any of a variety of devices such as general purposes computers, wireless communication device handsets, digital cameras, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

The coding techniques discussed herein may be embodied in an example video encoding and decoding system. A system includes a source device that provides encoded video data to be decoded at a later time by a destination device. In particular, the source device provides the video data to destination device via a computer-readable medium. The source device and the destination device may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, the source device and the destination device may be equipped for wireless communication.

The destination device may receive the encoded video data to be decoded via the computer-readable medium. The computer-readable medium may comprise any type of medium or device capable of moving the encoded video data from source device to destination device. In one example, computer-readable medium may comprise a communication medium to enable source device to transmit encoded video data directly to destination device in real-time. The encoded video data may be modulated according to a communication standard, such as a wireless communication protocol, and transmitted to destination device. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device to destination device.

In some examples, encoded data may be output from output interface to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device. Destination device may access stored video data from the storage device via streaming or download. The file server may be any type of server capable of storing encoded video data and transmitting that encoded video data to the destination device. Example file servers include a web server (e.g., for a website), an FTP server, network attached storage (NAS) devices, or a local disk drive. Destination device may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system may be configured to support one-way or two-way video transmission to support applications such as video streaming, video playback, video broadcasting, and/or video telephony.

In one example the source device includes a video source, a video encoder, and an output interface. The destination device may include an input interface, a video decoder, and a display device. The video encoder of source device may be configured to apply the techniques disclosed herein. In other examples, a source device and a destination device may include other components or arrangements. For example, the source device may receive video data from an external video source, such as an external camera. Likewise, the destination device may interface with an external display device, rather than including an integrated display device.

As noted the computer-readable medium may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from the source device and provide the encoded video data to the destination device, e.g., via network transmission. Similarly, a computing device of a medium production facility, such as a disc stamping facility, may receive encoded video data from the source device and produce a disc containing the encoded video data. Therefore, the computer-readable medium may be understood to include one or more computer-readable media of various forms, in various examples. The input interface of the destination device receives information from the computer-readable medium. A display device displays the decoded video data to a user, and may comprise any of a variety of display devices such as a cathode ray tube (CRT), a liquid crystal display (LCD), a plasma display, an organic light emitting diode (OLED) display, or another type of display device. Various embodiments of the invention have been described.

1. A mobile device comprising:
a memory; and
a processor configured to:
determine an ambient color temperature of a subject;
determine a color temperature for outputting light from a display facing a first direction based on a light output characteristic for a dedicated illumination element facing the first direction, the determined ambient color temperature, and a desired color temperature of the subject;
illuminate the subject using both the dedicated illumination element and the display, wherein the display outputs light based on the determined color temperature for outputting light from the display; and
capture, using an image sensor facing the first direction, an image of the subject during the subject being illuminated using both the dedicated illumination element and the display.

2. The mobile device of claim 1, wherein the display outputs light based on the determined color temperature for outputting light from the display by outputting light approximately uniformly across an entire surface area of the display.

3. The mobile device of claim 1, wherein the display outputs light based on the determined color temperature for outputting light from the display by outputting light from a plurality of areas including outputting light from a first area of the display according to a first parameter and outputting light from a second area of the display according to a second parameter, wherein a combined light output from the plurality of areas is based on the determined color temperature for outputting light from the display.

4. The mobile device of claim 1, wherein the processor is further configured to select the light output characteristic for the dedicated illumination element from a plurality of light output characteristics available for the dedicated illumination element.

5. The mobile device of claim 4, wherein the light output characteristic is at least one of a color temperature and luminance for the dedicated illumination element.

6. The mobile device of claim 1, wherein the processor is further configured to determine a luminance for outputting light from the display based on the light output characteristic for the dedicated illumination element, the determined ambient color temperature, and the desired color temperature of the subject.

7. The mobile device of claim 1, wherein the processor is further configured to cause display of a preview of the subject on the display prior to illuminating the subject, then illuminate the subject and capture the image of the subject, and subsequent to capturing the image of the subject, cause display of another preview of the subject on the display.

8. The mobile device of claim 1, wherein the desired color temperature for the subject is selectable by a user.

9. The mobile device of claim 1, wherein the desired color temperature is the determined ambient color temperature.

10. A method for illuminating a subject for image capture, the method comprising:
determining an ambient color temperature of a subject;
determining a color temperature for outputting light from a display facing a first direction based on a light output characteristic for a dedicated illumination element facing the first direction, the determined ambient color temperature, and a desired color temperature of the subject;
illuminating the subject using both the dedicated illumination element and the display, wherein the display outputs light based on the determined color temperature for outputting light from the display; and
capturing, using an image sensor facing the first direction, an image of the subject during the subject being illuminated using both the dedicated illumination element and the display.

11. The method of claim 10, wherein the display outputs light based on the determined color temperature for outputting light from the display by outputting light approximately uniformly across an entire surface area of the display.

12. The method of claim 10, wherein the display outputs light based on the determined color temperature for outputting light from the display by outputting light from a plurality of areas including outputting light from a first area of the display according to a first parameter and outputting light from a second area of the display according to a second parameter, wherein a combined light output from the plurality of areas is based on the determined color temperature for outputting light from the display.

13. The method of claim 10, further comprising selecting the light output characteristic for the dedicated illumination element from a plurality of light output characteristics available for the dedicated illumination element.

14. The method of claim 13, wherein the light output characteristic is at least one of a color temperature and luminance for the dedicated illumination element.

15. The method of claim 10, further comprising determining a luminance for outputting light from the display based on the light output characteristic for the dedicated illumination element, the determined ambient color temperature, and the desired color temperature of the subject.

16. The method of claim 10, further comprising displaying a preview of the subject on the display prior to illuminating the subject, then illuminating the subject and capturing the image of the subject, and subsequent to capturing the image of the subject displaying another preview of the subject on the display.

17. The method of claim 10, wherein the desired color temperature for the subject is selectable by a user.

18. The method of claim 10, wherein the desired color temperature is the determined ambient color temperature.

19. A mobile device comprising:
means for determining an ambient color temperature of a subject;
means for determining a color temperature for outputting light from a display facing a first direction based on a light output characteristic for a dedicated illumination element facing the first direction, the determined ambient color temperature, and a desired color temperature of the subject;
means for illuminating the subject using both the dedicated illumination element and the display, wherein the display outputs light based on the determined color temperature for outputting light from the display; and
means for capturing, using an image sensor facing the first direction, an image of the subject during the subject being illuminated using both the dedicated illumination element and the display.

20. The mobile device of claim 19, further comprising means for selecting the light output characteristic for the dedicated illumination element from a plurality of light output characteristics available for the dedicated illumination element.

21. The mobile device of claim 19, further comprising means for determining a luminance for outputting light from the display based on the light output characteristic for the dedicated illumination element, the determined ambient color temperature, and the desired color temperature of the subject.

22. The mobile device of claim 19, further comprising means for displaying a preview of the subject on the display prior to illuminating the subject, then illuminating the subject and capturing the image of the subject, and subsequent to capturing the image of the subject displaying of another preview of the subject on the display.

23. The mobile device of claim 19, wherein the desired color temperature for the subject is selectable by a user.

24. The mobile device of claim 19, wherein the desired color temperature is the determined ambient color temperature.

25. A non-transitory computer readable medium having stored thereon instructions that, when executed, cause a processor of a device to perform a method for illuminating a subject for image capture, the method comprising:
determining an ambient color temperature of a subject;
determining a color temperature for outputting light from a display facing a first direction based on a light output characteristic for a dedicated illumination element facing the first direction, the determined ambient color temperature, and a desired color temperature of the subject;
illuminating the subject using both the dedicated illumination element and the display, wherein the display outputs light based on the determined color temperature for outputting light from the display; and
capturing, using an image sensor facing the first direction, an image of the subject during the subject being illuminated using both the dedicated illumination element and the display.

26. The computer readable medium of claim 25, wherein the method further comprises selecting the light output characteristic for the dedicated illumination element from a plurality of light output characteristics available for the dedicated illumination element.

27. The computer readable medium of claim 25, wherein the method further comprises determining a luminance for outputting light from the display based on the light output characteristic for the dedicated illumination element, the determined ambient color temperature, and the desired color temperature of the subject.

28. The computer readable medium of claim 25, wherein the method further comprises displaying a preview of the subject on the display prior to illuminating the subject, then illuminating the subject and capturing the image of the subject, and subsequent to capturing the image of the subject displaying of another preview of the subject on the display.

29. The computer readable medium of claim 25, wherein the desired color temperature for the subject is selectable by a user.

30. The computer readable medium of claim 25, wherein the desired color temperature is the determined ambient color temperature.
